(19) United States
(12) Patent Application Publication
(10) Pub. No.: US 2025/0227236 A1
(43) Pub. Date: Jul. 10, 2025

(54) ADAPTIVE SLICE SCAN METHOD-BASED IMAGE ENCODING/DECODING METHOD AND APPARATUS, AND RECORDING MEDIUM FOR STORING BITSTREAM

(71) Applicant: LG Electronics Inc., Seoul (KR)

(72) Inventors: Hendry TAN, Seoul (KR); Seung Hwan KIM, Seoul (KR)

(21) Appl. No.: 18/854,877

(22) PCT Filed: Apr. 7, 2023
(86) PCT No.: PCT/KR2023/004729

§ 371 Date: Oct. 7, 2024

Related U.S. Application Data
(60) Provisional application No. 63/328,734, filed on Apr. 7, 2022.
(60) Provisional application No. 63/329,332, filed on Apr. 8, 2022.

(51) Int. Cl. H04N 19/129; H04N 19/105; H04N 19/172; H04N 19/174

(52) U.S. Cl. CPC H04N 19/129; H04N 19/105; H04N 19/172; H04N 19/174

(57) ABSTRACT

An image encoding/decoding method and apparatus are provided. The image decoding method may comprise determining a decoding order of a plurality of slices within a current picture and decoding the plurality of slices based on the determined decoding order. Based on the decoding order of the plurality of slices being determined to be a different order from a raster scan order, a left neighboring slice located on a left side of a current slice within the current picture and a top neighboring slice located above the current slice may be restricted to precede the current slice in decoding order.

### TECHNICAL FIELD

The present disclosure relates to an image encoding/decoding method and apparatus and a recording medium for storing a bitstream, and, more particularly, to an image encoding/decoding method and apparatus based on an adaptive slice scan scheme, and a recording medium for storing a bitstream generated by the image encoding method/apparatus of the present disclosure.

### BACKGROUND ART

Recently, demand for high-resolution and high-quality images such as high definition (HD) images and ultra high definition (UHD) images is increasing in various fields. As resolution and quality of image data are improved, the amount of transmitted information or bits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an encoding/decoding method and apparatus based on an adaptive slice scan scheme according to the position and shape of a slice within a picture.

Another object of the present disclosure is to provide an encoding/decoding method and apparatus based on an adaptive slice scan method according to whether subpicture across filtering is allowed.

Another object of the present disclosure is to provide an encoding/decoding method and apparatus based on a flexible arbitrary slice scan scheme.

Another object of the present disclosure is to provide an encoding/decoding method and apparatus capable of performing in-loop filtering without decoding delay.

Another object of the present disclosure is to provide a non-transitory computer-readable recording medium for storing a bitstream generated by an image encoding method or apparatus according to the present disclosure.

Another object of the present disclosure is to provide a non-transitory computer-readable recording medium for storing a bitstream received, decoded and used to reconstruct an image by an image decoding apparatus according to the present disclosure.

Another object of the present disclosure is to provide a method of transmitting a bitstream generated by an image encoding method or apparatus according to the present disclosure.

The technical problems solved by the present disclosure are not limited to the above technical problems and other technical problems which are not described herein will become apparent to those skilled in the art from the following description.

### Technical Solution

An image decoding method according to an aspect of the present disclosure may comprise determining a decoding order of a plurality of slices within a current picture and decoding the plurality of slices based on the determined decoding order. Based on the decoding order of the plurality of slices being determined to be a different order from a raster scan order, a left neighboring slice located on a left side of a current slice within the current picture and a top neighboring slice located above the current slice may be restricted to precede the current slice in decoding order.

An image decoding apparatus according to another aspect of the present disclosure may comprise a memory and at least one processor. The at least one processor may determine a decoding order of a plurality of slices within a current picture and decode the plurality of slices based on the determined decoding order. Based on the decoding order of the plurality of slices being determined to be a different order from a raster scan order, a left neighboring slice located on a left side of a current slice within the current picture and a top neighboring slice located above the current slice may be restricted to precede the current slice in decoding order.

An image encoding method according to another aspect of the present disclosure may comprise determining an encoding order of a plurality of slices within a current picture and encoding the plurality of slices based on the determined encoding order. Based on the encoding order of the plurality of slices being determined to be a different order from a raster scan order, a left neighboring slice located on a left side of a current slice within the current picture and a top neighboring slice located above the current slice may be restricted to precede the current slice in encoding order.

In addition, a computer-readable recording medium according to another aspect of the present disclosure may store the bitstream generated by the image encoding apparatus or the image encoding method of the present disclosure.

Also, a transmission method according to another aspect of the present disclosure may transmit a bitstream generated by an image encoding apparatus or method of the present disclosure.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

Also, according to the present disclosure, it is possible to provide an encoding/decoding method and apparatus based on an adaptive slice scan scheme according to the position and shape of a slice within a picture.

Also, according to the present disclosure, it is possible to provide an encoding/decoding method and apparatus based on an adaptive slice scan method according to whether subpicture across filtering is allowed.

Also, according to the present disclosure, it is possible to provide an encoding/decoding method and apparatus based on a flexible arbitrary slice scan scheme.

Also, according to the present disclosure, it is possible to provide an encoding/decoding method and apparatus capable of performing in-loop filtering without decoding delay.

Also, according to the present disclosure, it is possible to provide a non-transitory recording medium for storing a bitstream generated by an image encoding method or apparatus according to the present disclosure.

Also, according to the present disclosure, it is possible to provide a non-transitory recording medium for storing a bitstream received, decoded and used to reconstruct an image by an image decoding apparatus according to the present disclosure.

According to the present disclosure, it is possible to provide a method of transmitting a bitstream generated by an image encoding method according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a view schematically showing a video coding system, to an embodiment of the present disclosure is applicable.

FIG. 2 is a view schematically showing an image encoding apparatus, to which an embodiment of the present disclosure is applicable.

FIG. 3 is a view schematically showing an image decoding apparatus, to which an embodiment of the present disclosure is applicable.

FIGS. 4 to 7 are diagrams showing examples of partitioning a picture.

FIG. 8 is a schematic flowchart of an image decoding procedure to which an embodiment according to the present disclosure is applicable.

FIG. 9 is a schematic flowchart of an image encoding procedure to which an embodiment according to the present disclosure is applicable.

FIG. 10 is a diagram showing an example of a hierarchical structure for a coded image/video.

FIG. 11 is a diagram for explaining a slice scan scheme.

FIGS. 12 to 14 are diagrams for explaining an adaptive slice scan scheme according to an embodiment of the present disclosure.

FIGS. 15 to 19 are diagrams for explaining an adaptive slice scan scheme according to an embodiment of the present disclosure.

FIG. 20 is a flowchart illustrating an image encoding method according to an embodiment of the present disclosure.

FIG. 21 is a flowchart illustrating an image decoding method according to an embodiment of the present disclosure.

FIG. 22 is a view showing a content streaming system, to which an embodiment of the present disclosure is applicable.

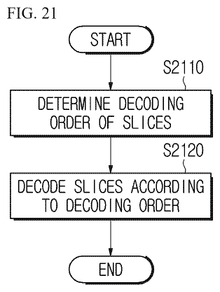

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and terms used in the present disclosure may have a general meaning commonly used in the technical field, to which the present disclosure belongs, unless newly defined in the present disclosure.

In the present disclosure, a “video” may mean a set of images over time.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

A “pixel” or a “pel” may mean a smallest unit constituting one picture (or image). In addition, “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”, “decoding target block” or “processing target block”. When prediction is performed, “current block” may mean “current prediction block” or “prediction target block”. When transform (inverse transform)/quantization (dequantization) is performed, “current block” may mean “current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “A/B/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

In the present disclosure, “at least one of A, B, and C” may mean “only A,” “only B.” “only C,” or “any and all combinations of A, B, and C.” In addition, “at least one A, B or C” or “at least one A, B and/or C” may mean “at least one A, B and C.”

Parentheses used in the present disclosure may mean “for example.” For example, if “prediction (intra prediction)” is indicated, “intra prediction” may be proposed as an example of “prediction.” In other words, “prediction” in the present disclosure is not limited to “intra prediction,” and “intra prediction” may be proposed as an example of “prediction.” In addition, even when “prediction (i.e., intra prediction)” is indicated, “intra prediction” may be proposed as an example of “prediction.”

### Overview of Video Coding System

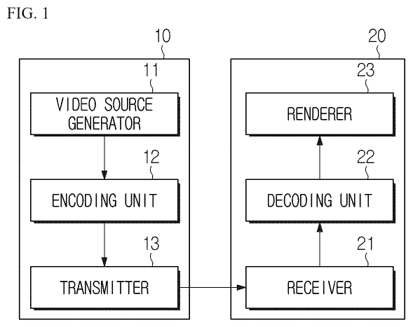

FIG. 1 is a view showing a video coding system, to which an embodiment of the present disclosure is applicable.

The video coding system according to an embodiment may include an encoding device 10 and a decoding device 20. The encoding device 10 may deliver encoded video and/or image information or data to the decoding device 20 in the form of a file or streaming via a digital storage medium or network.

The source device 10 according to an embodiment may include a video source generator 11, an encoding unit 12 and a transmitter 13. The decoding device 20 according to an embodiment may include a receiver 21, a decoding unit 22 and a renderer 23. The encoding unit 12 may be called a video/image encoding device, and the decoding unit 22 may be called a video/image decoding device. The transmitter 13 may be included in the encoding unit 12. The receiver 21 may be included in the decoding unit 22. The renderer 23 may include a display and the display may be configured as a separate device or an external component.

The video source generator 11 may acquire a video/image through a process of capturing, synthesizing or generating the video/image. The video source generator 11 may include a video/image capture device and/or a video/image generating device. The video/image capture device may include, for example, one or more cameras, video/image archives including previously captured video/images, and the like. The video/image generating device may include, for example, computers, tablets and smartphones, and may (electronically) generate video/images. For example, a virtual video/image may be generated through a computer or the like. In this case, the video/image capturing process may be replaced by a process of generating related data.

The encoding unit 12 may encode an input video/image. The encoding unit 12 may perform a series of procedures such as prediction, transform, and quantization for compression and coding efficiency. The encoding unit 12 may output encoded data (encoded video/image information) in the form of a bitstream.

The transmitter 13 may transmit the encoded video/image information or data output in the form of a bitstream to the receiver 21 of the decoding device 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

### Overview of Image Encoding Apparatus

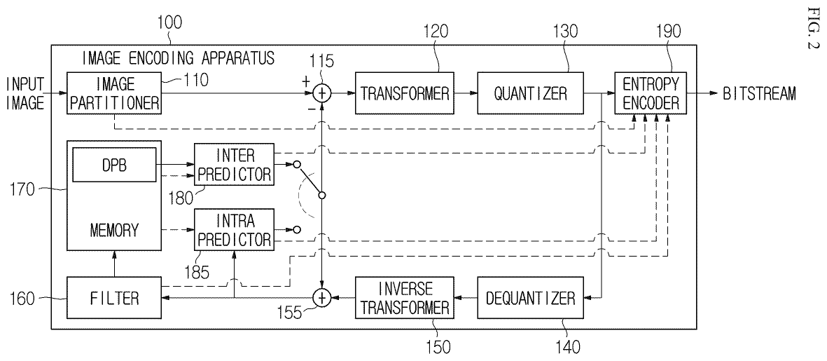

FIG. 2 is a view schematically showing an image encoding apparatus, to which an embodiment of the present disclosure is applicable.

As shown in FIG. 2, the image encoding device 100 may include an image partitioner 110, a subtractor 115, a transformer 120, a quantizer 130, a dequantizer 140, an inverse transformer 150, an adder 155, a filter 160, a memory 170, an inter prediction unit 180, an intra prediction unit 185 and an entropy encoder 190. The inter prediction unit 180 and the intra prediction unit 185 may be collectively referred to as a “prediction unit”. The transformer 120, the quantizer 130, the dequantizer 140 and the inverse transformer 150 may be included in a residual processor. The residual processor may further include the subtractor 115.

All or at least some of the plurality of components configuring the image encoding device 100 may be configured by one hardware component (e.g., an encoder or a processor) in some embodiments. In addition, the memory 170 may include a decoded picture buffer (DPB) and may be configured by a digital storage medium.

The image partitioner 110 may partition an input image (or a picture or a frame) input to the image encoding device 100 into one or more processing units. For example, the processing unit may be called a coding unit (CU). The coding unit may be acquired by recursively partitioning a coding tree unit (CTU) or a largest coding unit (LCU) according to a quad-tree binary-tree ternary-tree (QT/BT/TT) structure. For example, one coding unit may be partitioned into a plurality of coding units of a deeper depth based on a quad tree structure, a binary tree structure, and/or a ternary structure. For partitioning of the coding unit, a quad tree structure may be applied first and the binary tree structure and/or ternary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform, and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The prediction unit (the inter prediction unit 180 or the intra prediction unit 185) may perform prediction on a block to be processed (current block) and generate a predicted block including prediction samples for the current block. The prediction unit may determine whether intra prediction or inter prediction is applied on a current block or CU basis. The prediction unit may generate various information related to prediction of the current block and transmit the generated information to the entropy encoder 190. The information on the prediction may be encoded in the entropy encoder 190 and output in the form of a bitstream.

The intra prediction unit 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra prediction unit 185 may determine the prediction mode applied to the current block by using a prediction mode applied to a neighboring block.

The inter prediction unit 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU), and the like. The reference picture including the temporal neighboring block may be called a collocated picture (colPic). For example, the inter prediction unit 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter prediction unit 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The prediction unit may generate a prediction signal based on various prediction methods and prediction techniques described below. For example, the prediction unit may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CIIP). In addition, the prediction unit may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the prediction unit may be used to generate a reconstructed signal or to generate a residual signal. The subtractor 115 may generate a residual signal (residual block or residual sample array) by subtracting the prediction signal (predicted block or prediction sample array) output from the prediction unit from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/external element of the image encoding device 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter prediction unit 180 or the intra prediction unit 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

Meanwhile, luma mapping with chroma scaling (LMCS) is applicable in a picture encoding and/or reconstruction process.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter prediction unit 180. When inter prediction is applied through the image encoding device 100, prediction mismatch between the image encoding device 100 and the image decoding apparatus may be avoided and encoding efficiency may be improved.

The DPB of the memory 170 may store the modified reconstructed picture for use as a reference picture in the inter prediction unit 180. The memory 170 may store the motion information of the block from which the motion information in the current picture is derived (or encoded) and/or the motion information of the blocks in the picture that have already been reconstructed. The stored motion information may be transmitted to the inter prediction unit 180 and used as the motion information of the spatial neighboring block or the motion information of the temporal neighboring block. The memory 170 may store reconstructed samples of reconstructed blocks in the current picture and may transfer the reconstructed samples to the intra prediction unit 185.

### Overview of Image Decoding Apparatus

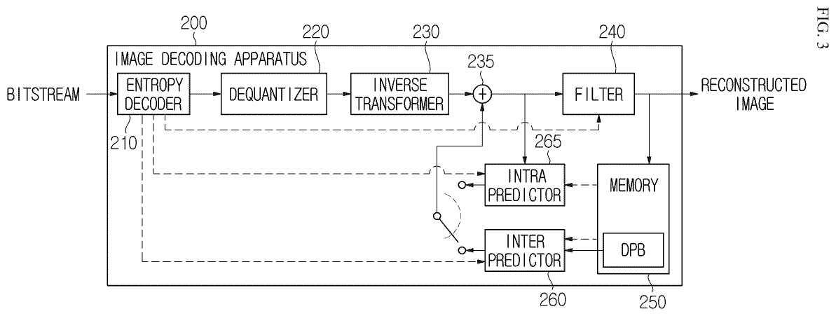

FIG. 3 is a view schematically showing an image decoding apparatus, to which an embodiment of the present disclosure is applicable.

As shown in FIG. 3, the image decoding device 200 may include an entropy decoder 210, a dequantizer 220, an inverse transformer 230, an adder 235, a filter 240, a memory 250, an inter prediction unit 260 and an intra prediction unit 265. The inter prediction unit 260 and the intra prediction unit 265 may be collectively referred to as a “prediction unit”. The dequantizer 220 and the inverse transformer 230 may be included in a residual processor.

All or at least some of a plurality of components configuring the image decoding device 200 may be configured by a hardware component (e.g., a decoder or a processor) according to an embodiment. In addition, the memory 170 may include a decoded picture buffer (DPB) or may be configured by a digital storage medium.

The image decoding device 200, which has received a bitstream including video/image information, may reconstruct an image by performing a process corresponding to a process performed by the image encoding device 100 of FIG. 2. For example, the image decoding device 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding device 200 may be reproduced through a reproducing apparatus (not shown).

The image decoding device 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the prediction unit (the inter prediction unit 260 and the intra prediction unit 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/external element of the image decoding device 200, or the receiver may be a component of the entropy decoder 210.

Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter prediction unit 160 or the intra prediction unit 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The prediction unit may perform prediction on the current block and generate a predicted block including prediction samples for the current block. The prediction unit may determine whether intra prediction or inter prediction is applied to the current block based on the information on the prediction output from the entropy decoder 210 and may determine a specific intra/inter prediction mode (prediction technique).

It is the same as described in the prediction unit of the image encoding device 100 that the prediction unit may generate the prediction signal based on various prediction methods (techniques) which will be described later.

The intra prediction unit 265 may predict the current block by referring to the samples in the current picture. The description of the intra prediction unit 185 is equally applied to the intra prediction unit 265,

The inter prediction unit 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter prediction unit 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the prediction unit (including the inter prediction unit 260 and/or the intra prediction unit 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter prediction unit 260. The memory 250 may store the motion information of the block from which the motion information in the current picture is derived (or decoded) and/or the motion information of the blocks in the picture that have already been reconstructed. The stored motion information may be transmitted to the inter prediction unit 260 so as to be utilized as the motion information of the spatial neighboring block or the motion information of the temporal neighboring block. The memory 250 may store reconstructed samples of reconstructed blocks in the current picture and transfer the reconstructed samples to the intra prediction unit 265.

In the present disclosure, the embodiments described in the filter 160, the inter prediction unit 180, and the intra prediction unit 185 of the image encoding device 100 may be equally or correspondingly applied to the filter 240, the inter prediction unit 260, and the intra prediction unit 265 of the image decoding device 200.

### Overview of Image Partitioning

The video/image encoding/decoding method according to the present disclosure may be performed based on the following image partitioning structure. Specifically, procedures such as prediction, residual processing ((inverse) transform, (de)quantization, etc.), syntax element coding, and filtering may be performed based on a CTU, CU (and/or TU, PU) derived based on the image partitioning structure. The block partitioning procedure may be performed in the image partitioner 110 of the encoding apparatus. The partitioning related information may be encoded by the entropy encoder 190 and transferred to the decoding apparatus 200 in the form of a bitstream. The entropy decoder 210 of the decoding apparatus may derive a block partitioning structure of a current picture based on the partitioning related information obtained from the bitstream, and based on this, may perform a series of procedures (e.g., prediction, residual processing, block/picture reconstruction, in-loop filtering, etc.) for image decoding. A CU size may be equal to a TU size or a plurality of TUs may be present in a CU region. Meanwhile, the CU size may generally indicate a luma component (sample) CB size. The TU size may generally indicate a luma component (sample) TB size. A chroma component (sample) CB or TB size may be derived based on a luma component (sample) CB or TB size according to a component ratio according to a color format (chroma format, e.g., 4:4:4, 4:2:2, 4:2:0, etc.) of a picture/image. The TU size may be derived based on maxTbSize. For example, when the CU size is greater than maxTbSize, a plurality of TUs (TBs) having maxTbSize may be derived from the CU, and transform/inverse transform may be performed in unit of TU (TB). In addition, for example, when intra prediction is applied, an intra prediction mode/type may be derived in unit of CU (or CB) and a neighboring reference sample derivation and prediction sample generation procedure may be performed in unit of TU (or TB). In this case, one or a plurality of TUs (or TBs) may be present in a CU (or a CB) region. In this case, the plurality of TUs (or TBs) may share the same intra prediction mode/type.

In addition, in image encoding and decoding according to the present disclosure, an image processing unit may have a hierarchical structure. For example, one picture may be partitioned into one or more tiles, bricks, slices or tile groups. One slice may include one or more bricks. One brick may include one or more CTU rows in a tile. A slice may include an integer number of bricks of a picture. One tile group may include one or more tiles. One tile may include one or more CTUs. The CTU may be partitioned into one or more CUs as described above. A tile may be composed of a rectangular region of CTUs within a particular row and a particular column in a picture. The tile group may include an integer number of tiles according to tile-raster scan within a picture. A slice header may signal information/parameters applicable to the slice (blocks within the slice). When the encoding/decoding apparatus has a multi-core processor, an encoding/decoding procedure for the tile, slice, brick or tile group may be performed in parallel. In the present disclosure, the slice or the tile group may be used interchangeably. That is, the tile group header may be called a slice header. Here, the slice may have one of slice types including an intra (I) slice, a predictive (P) slice and a bi-predictive (B) slice. For blocks in the I slice, inter prediction may not be used and only intra prediction may be used for prediction. Of course, even in this case, an original sample value may be coded and signalled without prediction. For blocks in the P slice, intra prediction or inter prediction may be used, and only uni-prediction may be used when inter prediction is used. Meanwhile, for blocks in the B slice, intra prediction or inter prediction may be used, and up to bi prediction may be used when inter prediction is used.

In the encoding apparatus, a tile/tile group, a brick, a slice, a maximum and minimum coding unit size may be determined according to the characteristics (e.g., resolution) of an image or in consideration of coding efficiency or parallel processing, and information thereon or information capable of deriving the same may be included in a bitstream.

In the decoding apparatus, information indicating whether a CTU in a tile/tile group, brick or slice of a current picture is partitioned into a plurality of coding units may be obtained. When such information is obtained (transmitted) only under a specific condition, efficiency can increase.

The slice header (slice header syntax) may include information/parameter which is commonly applicable to the slice. The APS (APS syntax) or PPS (PPS syntax) may include information/parameter which is commonly applicable to one or more pictures. The SPS (SPS syntax) may include information/parameter which is commonly applicable to one or more sequences. The VPS (VPS syntax) may include information/parameter which is commonly applicable to multiple layers. The DPS (DPS syntax) may include information/parameter which is commonly applicable to the overall video. The DPS may include information/parameter related to concatenation of a coded video sequence (CVS). In the present disclosure, a higher level syntax may include at least one of the APS syntax, the PPS syntax, the SPS syntax, the VPS syntax, the DPS syntax or the slice header syntax.

In addition, for example, information on partitioning and configuration of the tile/tile group/brick/slice may be constructed in the encoding apparatus through the higher level syntax and transferred to the decoding apparatus in the form of a bitstream.

### Partitioning Structure

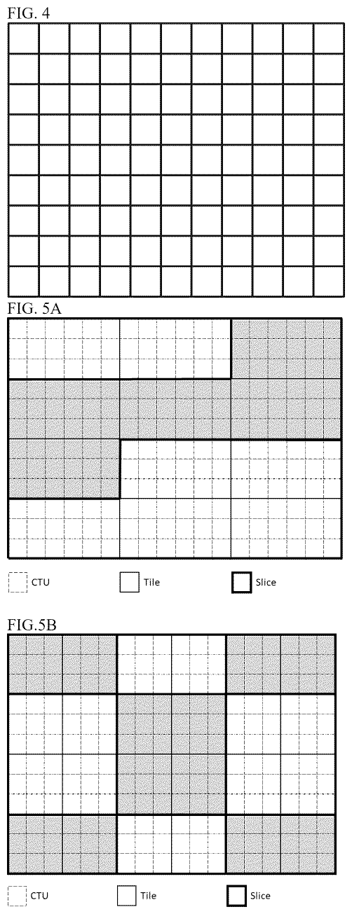

Pictures may be partitioned into a sequence of coding tree units (CTUs). A CTU may correspond to a coding tree block (CTB). Alternatively, the CTU may include a coding tree block of luma samples and two coding tree blocks of chroma samples corresponding thereto. For example, for a picture containing three sample arrays, the CTU may include an N×N block of luma samples and two corresponding blocks of chroma samples. FIG. 4 shows an example in which one picture is partitioned into multiple CTUs.

The maximum allowable size of the CTU for coding and prediction may be different from the maximum allowable size of the CTU for transform. For example, even if the maximum allowable size of the CTU for transform is 64×64, the maximum allowable size of the luma block in the CTU for coding and prediction may be 128×128.

In addition, the picture may be partitioned into one or more tile rows and one or more tile columns. The tile may be a sequence of CTUs covering a rectangular area of the picture. The CTUs of the tile may be scanned in raster scan order within the tile.

The slice may consist of an integer number of complete tiles or an integer number of contiguous complete CTU rows within a tile of a picture. Two modes of slices may be supported: one is a raster scan slice mode and the other is a rectangular slice mode.

In the raster scan slice mode, a slice may include a sequence of complete tiles in a tile raster scan of a picture. In the present disclosure, a slice according to the raster scan slice mode may be referred to as a raster scan slice.

In the rectangular slice mode, a slice may include several complete tiles that collectively form a rectangular area of a picture or several contiguous complete CTU rows of one tile that collectively form a rectangular area of a picture. In the present disclosure, a slice according to the rectangular slice mode may be referred to as a rectangular slice. The tiles included in a rectangular slice may be scanned in tile raster scan order within a rectangular area corresponding to the slice.

Meanwhile, one or more slices may constitute a subpicture. That is, a subpicture may include one or more slices that collectively cover a rectangular area of a picture.

FIGS. 5a to 5c are diagrams illustrating examples of partitioning a picture.

Referring first to FIG. 5a, in the raster scan slice mode, a picture may be partitioned into 12 tiles and 3 raster scan slices.

Referring to FIG. 5b, in the rectangular slice mode, a picture may be partitioned into 24 tiles (i.e., 6 tile rows and 4 tile columns) and 9 rectangular slices.

Referring to FIG. 5c, a picture may be partitioned into 4 tiles (i.e., 2 tile rows and 2 tile columns) and 4 rectangular slices.

FIG. 6 is a diagram showing an example of partitioning a picture into subpictures.

Referring to FIG. 6, a picture may be partitioned into 28 subpictures with varying dimensions.

When a picture is coded using three separate colour planes (i.e., separate_colour_plane_flag=1), a slice may contain only CTUs of one colour component identified by corresponding values of color_plane_id, and each colour component array of the picture may consist of slices having the same colour_plane_id value. Coded slices having different colour_plane_id values within the picture may be interleaved with each other under the constraint that for each colour_plane_id value, the coded slice NAL units having the colour_plane_id of the corresponding value must be present in increasing order of CTU addresses in tile scan order for the first CTU of each coded slice NAL unit.

When separate_colour_plane_flag is 0, each CTU of a picture may be included in exactly one slice. In contrast, when separate_colour_plane_flag is 1, each CTU of a colour component may be included in exactly one slice (i.e., information about each CTU of a picture is present in exactly three slices, and the three slices have different colour_plane_id values).

A tile may change the order of CTUs within a picture. For example, if a picture is partitioned into two or more tiles, the order of CTUs within each tile may follow the raster scan order, as in the example of FIG. 7, where the picture is partitioned into two tiles and each tile contains eight CTUs.

### Overview of Image Decoding/Encoding Procedure

In image/video coding, a picture configuring an image/video may be encoded/decoded according to a decoding order. A picture order corresponding to an output order of the decoded picture may be set differently from the decoding order, and, based on this, not only forward prediction but also backward prediction may be performed during inter prediction.

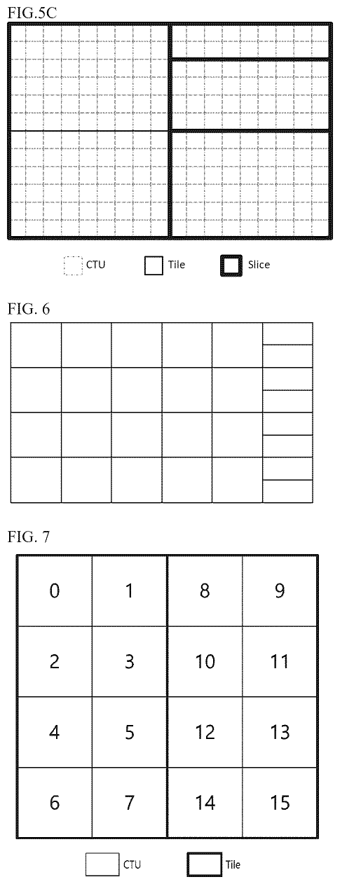

FIG. 8 is a schematic flowchart of an image decoding procedure to which an embodiment according to the present disclosure is applicable.

Each procedure shown in FIG. 8 may be performed by the image decoding apparatus of FIG. 3. For example, step S810 may be performed by the entropy decoder 210 of the image decoding apparatus, step S820 may be performed by the prediction units 265 and 260, step S830 may be performed by the residual processors 220 and 230, step S840 may be performed by the adder 235, and step S850 may be performed by the filter 240. Step S810 may include the information decoding (parsing) procedure described in the present disclosure, step S820 may include the inter/intra prediction procedure described in the present disclosure, step S830 may include a residual processing procedure described in the present disclosure, step S840 may include the block/picture reconstruction procedure described in the present disclosure, and step S850 may include the in-loop filtering procedure described in the present disclosure.

Referring to FIG. 8, the image decoding procedure may schematically include a procedure (S810) for obtaining image/video information (through decoding) from a bitstream, an image (picture) reconstruction procedure (S820 to S840) and an in-loop filtering procedure (S850) for a reconstructed picture. The picture reconstruction procedure may be performed based on prediction samples obtained through inter/intra prediction (S820) and residual samples obtained through residual processing (S830) (dequantization and inverse transform of the quantized transform coefficient). A modified reconstructed picture may be generated through the in-loop filtering procedure for the reconstructed picture generated through the picture reconstruction procedure, the modified reconstructed picture may be output as a decoded picture, stored in a decoded picture buffer (DPB) or a memory 250 of the image decoding apparatus and used as a reference picture in the inter prediction procedure when decoding the picture later. The in-loop filtering procedure (S850) may be omitted. In this case, the reconstructed picture may be output as a decoded picture, stored in a DPB or a memory 250 of the image decoding apparatus, and used as a reference picture in the inter prediction procedure when decoding the picture later. The in-loop filtering procedure (S850) may include a deblocking filtering procedure, a sample adaptive offset (SAO) procedure, an adaptive loop filter (ALF) procedure and/or a bi-lateral filter procedure, as described above, some or all of which may be omitted. In addition, one or some of the deblocking filtering procedure, the sample adaptive offset (SAO) procedure, the adaptive loop filter (ALF) procedure and/or the bi-lateral filter procedure may be sequentially applied or all of them may be sequentially applied. For example, after the deblocking filtering procedure is applied to the reconstructed picture, the SAO procedure may be performed. Alternatively, after the deblocking filtering procedure is applied to the reconstructed picture, the ALF procedure may be performed. This may be similarly performed even in the image encoding apparatus.

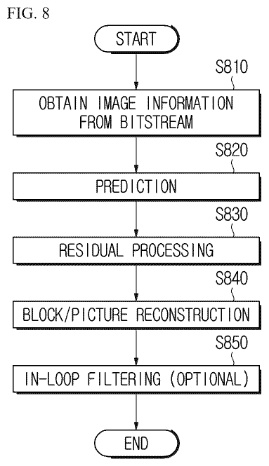

FIG. 9 is a schematic flowchart of an image encoding procedure to which an embodiment according to the present disclosure is applicable.

Each procedure shown in FIG. 9 may be performed by the image encoding apparatus of FIG. 2. For example, step S910 may be performed by the prediction units 180 and 185 of the image decoding apparatus, step S920 may be performed by residual processors 115, 120 and 130, and step S930 may be performed in the entropy encoder 190. Step S910 may include the inter/intra prediction procedure described in the present disclosure, step S920 may include the residual processing procedure described in the present disclosure, and step S930 may include the information encoding procedure described in the present disclosure.

Referring to FIG. 9, the image encoding procedure may schematically include not only a procedure for encoding and outputting information for picture reconstruction (e.g., prediction information, residual information, partitioning information, etc.) in the form of a bitstream but also a procedure for generating a reconstructed picture for a current picture and a procedure (optional) for applying in-loop filtering to a reconstructed picture. The image encoding apparatus may derive (modified) residual samples from a quantized transform coefficient through the dequantizer 140 and the inverse transformer 150, and generate the reconstructed picture based on the prediction samples which are output of step S910 and the (modified) residual samples. The reconstructed picture generated in this way may be equal to the reconstructed picture generated in the image decoding apparatus. The modified reconstructed picture may be generated through the in-loop filtering procedure for the reconstructed picture, and the modified reconstructed picture may be stored in the decoded picture buffer 170 or a memory, and may be used as a reference picture in the inter prediction procedure when encoding the picture later, similarly to the decoding apparatus. As described above, in some cases, some or all of the in-loop filtering procedure may be omitted. When the in-loop filtering procedure is performed, (in-loop) filtering related information (parameter) may be encoded in the entropy encoder 190 and output in the form of a bitstream, and the image decoding apparatus may perform the in-loop filtering procedure using the same method as the image encoding apparatus based on the filtering related information.

Through such an in-loop filtering procedure, noise occurring during image/video coding, such as blocking artifact and ringing artifact, may be reduced and subjective/objective visual quality may be improved. In addition, by performing the in-loop filtering procedure in both the image encoding apparatus and the image decoding apparatus, the image encoding apparatus and the image decoding apparatus may derive the same prediction result, picture coding reliability may be increased and the amount of data to be transmitted for picture coding may be reduced.

As described above, the image (picture) reconstruction procedure may be performed not only in the image decoding apparatus but also in the image encoding apparatus. A reconstructed block may be generated based on intra prediction/inter prediction in units of blocks, and a reconstructed picture including reconstructed blocks may be generated. When a current picture/slice/tile group is an I picture/slice/tile group, blocks included in the current picture/slice/tile group may be reconstructed based on only intra prediction. On the other hand, when the current picture/slice/tile group is a P or B picture/slice/tile group, blocks included in the current picture/slice/tile group may be reconstructed based on intra prediction or inter prediction. In this case, inter prediction may be applied to some blocks in the current picture/slice/tile group and intra prediction may be applied to the remaining blocks. The color component of the picture may include a luma component and a chroma component, and the methods and embodiments of the present disclosure are applicable to both the luma component and the chroma component unless explicitly limited in the present disclosure.

### Example of Coding Layer Structure

A coded video/image of the present disclosure may be processed according to, for example, a coding layer and structure to be described later.

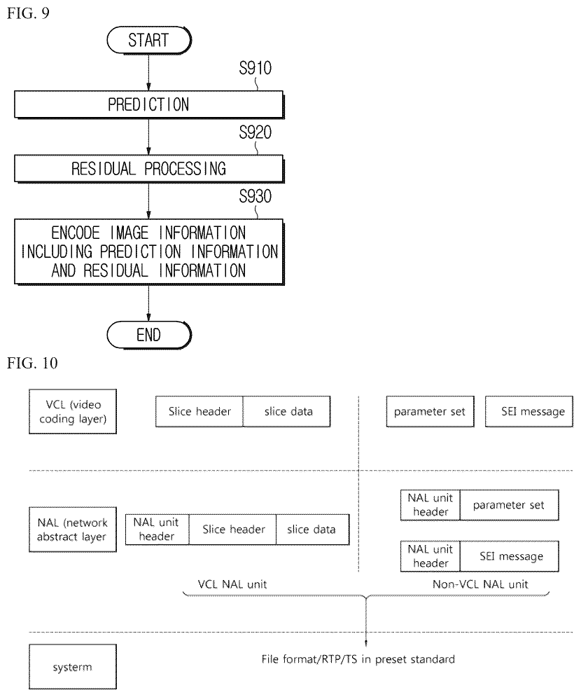

FIG. 10 is a view illustrating a layer structure for a coded image/video.

The coded image/video is classified into a video coding layer (VCL) for an image decoding process and handling itself, a lower system for transmitting and storing encoded information, and a network abstraction layer (NAL) present between the VCL and the lower system and responsible for a network adaptation function.

In the VCL, VCL data including compressed image data (slice data) may be generated or a parameter set including information such as a picture parameter set (PPS), a sequence parameter set (SPS) or a video parameter set (VPS) or a supplemental enhancement information (SEI) message additionally required for a decoding process of an image may be generated.

In the NAL, header information (NAL unit header) may be added to a raw byte sequence payload (RBSP) generated in the VCL to generate a NAL unit. In this case, the RBSP refers to slice data, a parameter set, an SEI message generated in the VCL. The NAL unit header may include NAL unit type information specified according to RBSP data included in a corresponding NAL unit.

As shown in FIG. 6, the NAL unit may be classified into a VCL NAL unit and a non-VCL NAL unit according to a type of the RBSP generated in the VCL. The VCL NAL unit may mean a NAL unit including information on an image (slice data), and the Non-VCL NAL unit may mean a NAL unit including information (parameter set or SEI message) required to decode an image.

The VCL NAL unit and the Non-VCL NAL unit may be attached with header information and transmitted through a network according to the data format of the lower system. For example, the NAL unit may be modified into data having a predetermined data format, such as H.266/VVC file format, RTP (Real-time Transport Protocol) or TS (Transport Stream), and transmitted through various networks.

As described above, in the NAL unit, a NAL unit type may be specified according to the RBSP data structure included in the corresponding NAL unit, and information on the NAL unit type may be stored in a NAL unit header and signaled. For example, this may be broadly classified into a VCL NAL unit type and a non-VCL NAL unit type based on whether the NAL unit includes information on an image (slice data). The VCL NAL unit type may be classified according to a property and type of a picture, and the Non-VCL NAL unit type may be classified according to a type of a parameter set.

An example of the NAL unit type specified according to the type of the parameter set/information included in the Non-VCL NAL unit type will be listed below.
APS (Adaptation Parameter Set) NAL unit: Type for NAL unit including APS
DPS (Decoding Parameter Set) NAL unit: Type for NAL unit including DPS
VPS (Video Parameter Set) NAL unit: Type for NAL unit including VPS
SPS (Sequence Parameter Set) NAL unit: Type for NAL unit including SPS
PPS (Picture Parameter Set) NAL unit: Type for NAL unit including PPS

The above-described NAL unit types may have syntax information on the NAL unit types, and the syntax information may be stored in a NAL unit header and signaled. For example, the syntax information may include nal_unit_type, and the NAL unit types may be specified by a value of nal_unit_type.

Meanwhile, as described above, one picture may include a plurality of slices, and one slice may include a slice header and slice data. In this case, one picture header may be further added to a plurality of slices (slice header and slice data set) in one picture. The picture header (picture header syntax) may include information/parameters commonly applicable to the picture. The slice header (slice header syntax) may include information/parameters commonly applicable to the slice. The APS (APS syntax) or PPS (PPS syntax) may include information/parameters commonly applicable to one or more slices or pictures. The SPS (SPS syntax) may include information/parameters commonly applicable to one or more sequences. The VPS (VPS syntax) may include information/parameters commonly applicable to multiple layers. The DPS (DPS syntax) may include information/parameters commonly applicable throughout the video. The DPS may include information/parameters related to the concatenation of CVS (coded video sequence). In the present disclosure, a high level syntax (HLS) may include at least one of the APS syntax, the PPS syntax, the SPS syntax, the VPS syntax, the DPS syntax, or the slice header syntax.

In the present disclosure, image/video information encoded by the encoding apparatus and signaled to the decoding apparatus in the form of a bitstream may include not only in-picture partitioning related information, intra/inter prediction information, residual information, in-loop filtering information but also information included in the slice header, APS, PPS, SPS and/or VPS.

### Problems of the Related Art

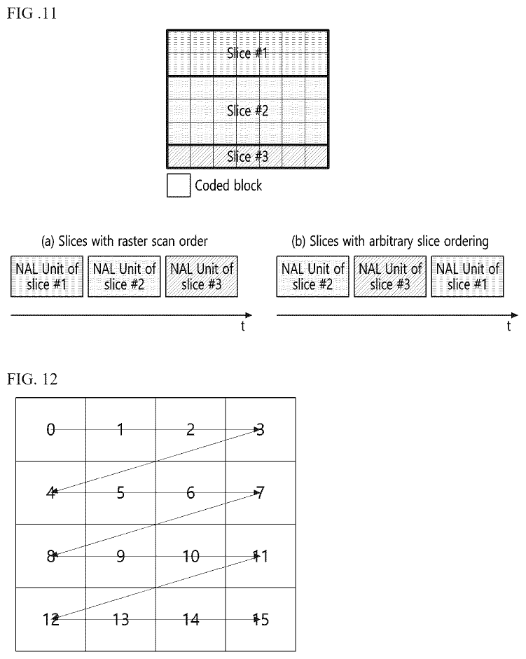

In most existing video codecs, only the raster scan order is generally applied to the slices within a picture, and arbitrary slice ordering has been proposed in some video codecs. Specific examples of the raster scan order and the arbitrary slice ordering are as shown in FIG. 11.

Referring to FIG. 11, one picture may include three slices (Slice #1 to Slice #3) having different sizes.

If the slices within the picture follow the raster scan order ((a) of FIG. 11), the slice NAL units of the picture may be encoded/decoded in the order of the first slice (Slice #1), the second slice (Slice #2), and the third slice (Slice #3).

In contrast, if the slices within the picture follow the arbitrary slice ordering ((b) of FIG. 11), the slice NAL units of the picture may be encoded/decoded in an arbitrary order, such as the second slice (Slice #2), the third slice (Slice #3), and the first slice (Slice #1).

In the case of following the arbitrary slice ordering, since the slices within a picture may be reordered according to a specific criterion (e.g., slice importance), it can have an advantage in terms of error resilience. However, since the existing method does not consider the in-loop filtering procedure, several problems may occur with respect to the implementation of the in-loop filter. For example, according to the existing method, since the slice order received by the image decoding apparatus may be an arbitrary order, it becomes difficult to implement a block-based in-loop filter. In other words, the image decoding apparatus cannot perform in-loop filtering on each coding block as soon as it decodes/reconstructs the corresponding coding block, and has a constraint that it must complete the reconstruction of all slices within the corresponding picture for the in-loop filtering. In addition, the above constraint causes a delay in encoding/decoding.

In order to solve such problems, the present disclosure proposes a more efficient slice scan scheme. The embodiments of the present disclosure described below are intended to explain representative aspects of the present disclosure, and may be applied independently or in combination of two or more.

### Embodiment 1

According to Embodiment 1 of the present disclosure, an adaptive (or flexible) slice scan scheme based on the position and shape of a slice within a picture may be provided. Specifically, a raster scan scheme or an arbitrary slice scan scheme can be selectively applied to slices within a picture. When an arbitrary slice scan scheme is applied to slices within a picture, left and top neighboring slices may be restricted to precede a current slice in decoding order. In addition, when the slices within a picture are not rectangular slices, the raster scan scheme shall be applied to the slices.

Embodiment 1 of the present disclosure may be implemented based on at least one of the following aspects. The following aspects may be applied individually, or may be applied in combination of two or more.

(Aspect 1): The order of the slices of a picture may not be the raster scan order.

(Aspect 2): If the order of the slices of a picture does not follow the raster scan order, the following constraints may apply.
a) If a specific slice A has a left neighboring slice B within the same picture, the slice B should precede the slice A in the decoding order. Here, since there may be one or more (left neighboring) slices between the slice B and the slice A, the slice B does not need to immediately precede the slice A in the decoding order.
b) If a specific slice A has a top neighboring slice B within the same picture, the slice B should precede the slice A in the decoding order. Here, since there may be one or more (top neighboring) slices between the slice B and the slice A, the slice B does not need to immediately precede the slice A in the decoding order.

(Aspect 3): If the coded slices are not rectangular slices, the order of the slices should follow the raster scan order. In contrast, if the coded slices are rectangular slices, the order of the slices may be the raster scan order, or may be any order other than the raster scan order, for example, arbitrary slice scan ordering according to Aspect 2 described above.

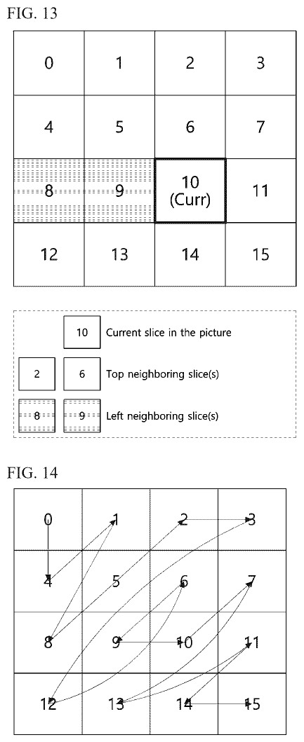

FIGS. 12 to 14 are diagrams for explaining an adaptive slice scan scheme according to an embodiment of the present disclosure. In FIGS. 12 to 14, it is assumed that one picture includes 16 rectangular slices.

First, referring to FIG. 12, since the slices within the picture are rectangular slices, the raster scan scheme may be applied according to Aspect 3 described above for the slices. Accordingly, the slices within a bitstream may have a raster scan order from slice #0 to slice #15, and may be sequentially encoded/decoded according to the order.

In contrast, when an arbitrary slice scan scheme is applied to slices within a picture, the constraints of Aspect 2 described above may be applied. Specifically, referring to FIG. 13, assuming that a current slice is slice #10, slices #8 and #9, which are left neighboring slices, may be restricted to precede slice #10 within the bitstream. In addition, slices #2 and #6, which are top neighboring slices, may be restricted to precede slice #10 within the bitstream. It goes without saying that the application results of the above-described constraints may vary depending on the position of a current slice. For example, assuming that the current slice is slice #0, since the left and top neighboring slices are not present, slice #0 may precede all other slices (i.e., slices #1 to #15) within the bitstream. Also, assuming that the current slice is slice #3, since only left neighboring slices are present and no top neighboring slices are not present, slice #3 may precede all other slices (i.e., slices #7, #11, and #15) of the corresponding slice column within the bitstream. Also, assuming that the current slice is slice #12, since only top neighboring slices are present and no left neighboring slices are present, slice #12 may precede all other slices (i.e., slices #13 to #15) of the corresponding slice row within the bitstream.

A specific example of the arbitrary slice scan ordering described above is as illustrated in FIG. 14. Referring to FIG. 14, an arbitrary slice scan scheme according to Aspect 2 above may be applied to slices within a picture. Accordingly, the slices within the bitstream may have an arbitrary order of slices #0, #4, #1, #8, #5, #2, #3, #12, #6, #9, #10, #7, #13, #11, #14, and #15, and may be sequentially encoded/decoded according to the order. In the above example, since the left neighboring slice (i.e., slice #4) and the top neighboring slice (i.e., slice #1) may be used to decode/reconstruct slice #5, for example, slice #5 may precede slice #3 in the decoding order, which satisfies the constraints of Aspect 2 above.

Above, according to Embodiment 1 of the present disclosure, a raster scan scheme or an arbitrary slice scan scheme may be selectively applied to slices within a picture. When an arbitrary slice scan scheme is applied to slices within a picture, the left and top neighboring slices may be restricted to precede the current slice in the decoding order. Accordingly, in-loop filtering for the current slice may be performed without reconstructing all the slices within the picture, thereby preventing encoding/decoding delay and further improving efficiency.

### Embodiment 2

When a picture is partitioned into multiple subpictures, in-loop filtering may be performed across a subpicture boundary, or may be performed only within each subpicture without crossing the subpicture boundary. Hereinafter, in-loop filtering performed across the subpicture boundary will be referred to as ‘subpicture across filtering.’

When subpicture across filtering is performed, slice(s) included in another subpicture may be referenced to perform in-loop filtering on a current slice, so the constraints of Aspect 2 described above in Embodiment 1 may be suitable for all slices within the picture. However, when subpicture across filtering is not performed, the neighboring slice(s) included in another subpicture are not referenced to perform in-loop filtering on the current slice, so the constraints of Aspect 2 described above in Embodiment 1 may be suitable only for slices included in the same subpicture. In this way, if subpicture across filtering is not performed, there is no dependency related to the in-loop filter between slices belonging to different subpictures, so it is necessary to limit the constraints of Aspect described above in Embodiment 1 to slices included in the same subpicture.

Accordingly, according to Embodiment 2 of the present disclosure, an adaptive (or flexible) slice scan scheme based on whether subpicture across filtering is allowed may be provided. Specifically, a raster scan scheme or an arbitrary slice scan scheme may be selectively applied to slices within a picture. When an arbitrary slice scan scheme is applied to slices within a picture, the range of left and top neighboring slices that is restricted to precede the current slice in decoding order may be determined to be the same picture range or the same subpicture range depending on whether subpicture across filtering is allowed.

Embodiment 2 of the present disclosure may be implemented based on at least one of the following aspects. The following aspects may be applied individually, or may be applied in a combination of two or more.

(Aspect 4): The order of slices of a picture and/or subpicture may not be the raster scan order. This may mean that, when a picture is partitioned into multiple subpictures, the encoding/decoding order of slices within the picture may be determined individually for each subpicture.

(Aspect 5): When there are two or more subpictures within a picture, subpicture across filtering is allowed, and the order of slices within the picture does not follow the raster scan order, the following constraints may be applied.
a) If a specific slice A has a left neighboring slice B within the ‘same picture’, the slice B should precede the slice A in the decoding order. Here, since one or more (left neighboring) slices may be present between the slice B and the slice A, the slice B does not need to immediately precede the slice A in the decoding order.
b) If a specific slice A has a top neighboring slice B within the ‘same picture’, the slice B should precede the slice A in the decoding order. Here, since one or more (top neighboring) slices may be present between the slice B and the slice A, the slice B does not need to immediately precede the slice A in the decoding order.

(Aspect 6): If there are two or more subpictures within a picture, subpicture across filtering is not allowed, and the order of slices in the picture does not follow the raster scan order, the following constraints may be applied:
a) If a specific slice A has a left neighboring slice B within the ‘same subpicture’, the slice B should precede the slice A in the decoding order. Here, since one or more (left neighboring) slices may be present between the slice B and the slice A, the slice B does not need to immediately precede the slice A in the decoding order.
b) If a specific slice A has a top neighboring slice B within the ‘same subpicture’, the slice B must precede the slice A in the decoding order. Here, since there may be one or more (top neighboring) slices between the slice B and the slice A, the slice B does not need to immediately precede the slice A in the decoding order.

(Aspect 7): If two slices within the same picture, for example, the slice A and the slice B, belong to different subpictures and subpicture across filtering is not allowed, the slice A may precede the slice B in the decoding order, or may follow the slice B. In other words, the decoding order of the slice A and the slice B may be determined regardless of the subpicture to which each slice belongs.

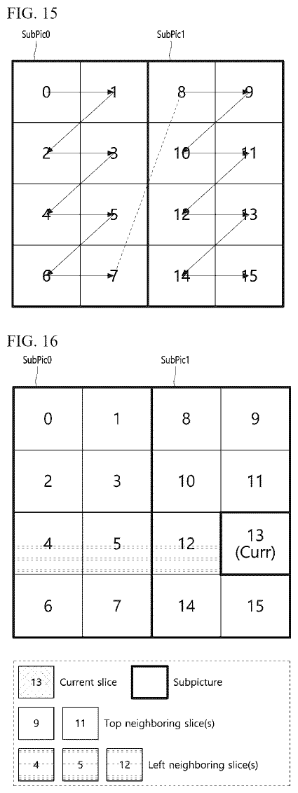

FIGS. 15 to 19 are diagrams for explaining an adaptive slice scan scheme according to an embodiment of the present disclosure. In FIGS. 15 to 19, it is assumed that one picture includes 16 rectangular slices, and the picture is vertically partitioned into two subpictures (Subpic0 and Subpic1).

First, referring to FIG. 15, a raster scan scheme may be applied to slices of each subpicture according to Aspect 4 described above. Accordingly, the slices may have a raster scan order from slice #0 to slice #7 of the first subpicture (SubPic0) and then from slice #8 to slice #15 of the second subpicture (SubPicl) within the bitstream, and may be sequentially encoded/decoded according to the order.

In contrast, when an arbitrary slice scan scheme is applied to slices within a picture, the constraints of Aspect 5 or 6 described above may be applied based on whether subpicture across filtering is allowed.

Specifically, referring to FIG. 16, when subpicture across filtering is allowed, the constraints of Aspect 5 may be applied. For example, assuming that the current slice is slice #13, the left neighboring slices #4, #5, and #12 within the same picture may be restricted to precede slice #13 within the bitstream. In addition, the top neighboring slices #9 and #11 within the same picture may be restricted to precede slice #13 within the bitstream. As with Aspect 2 of Embodiment 1, the result of applying Aspect 5 may vary depending on the position of the current slice within the picture.

A specific example of the arbitrary slice ordering described above is as illustrated in FIG. 17. Referring to FIG. 17, an arbitrary slice scan scheme according to Aspect 5 may be applied to slices within a picture. Accordingly, the slices within the bitstream may have an arbitrary order of slices #0, #1, #8, #2, #9, #3, #4, #10, #5, #11, #6, #12, #7, #13, #14, and #15, and may be sequentially encoded/decoded according to the order.

Next, referring to FIG. 18, when subpicture across filtering is not allowed, constraints of Aspect 6 may be applied. For example, assuming that the current slice is slice #13, only slice #12, which is the left neighboring slice within the same subpicture, may be restricted to precede slice #13 within the bitstream. In addition, slices #9 and #11, which are top neighboring slices within the same subpicture, may be restricted to precede slice #13 within the bitstream. As with Aspect 2 of Embodiment 1, the result of applying Aspect 6 may vary depending on the position of the current slice within the subpicture.

A specific example of the arbitrary slice scan ordering described above is as illustrated in FIG. 19. Referring to FIG. 19, an arbitrary slice scan scheme according to Aspect 6 may be applied to slices within a picture. Accordingly, the slices within the bitstream may have any order such as slice #0, #8, #2, #9, #4, #10, #6, #11, #1, #12, #3, #13, #5, #14, #15, and #7, and may be sequentially encoded/decoded according to the order.

Meanwhile, if each slice within a picture carries a NAL unit, the constraints of Aspects 5 and 6 described above may be described as follows:

For two coded slice NAL units A and B of a coded picture, assuming that subpicIdxA and subpicIdxB are subpicture level index values indicating the subpicture to which each slice belongs, the order of VCL NAL units within the coded picture may be constrained as follows.

(Constraint 1): If subpicture across filtering is allowed, and coded slice NAL unit A is a left neighbor of coded slice NAL unit B, and subpicIdxA is equal to or different from subpicidxB, then the slice NAL unit A shall precede the slice NAL unit B in decoding order.

(Constraint 2): If subpicture across filtering is allowed, and coded slice NAL unit A is an top neighbor of coded slice NAL unit B, and subpicIdxA is equal to or different from subpicIdxB, then the slice NAL unit A shall precede the slice NAL unit B in decoding order.

(Constraint 3): If subpicture across filtering is not allowed, and coded slice NAL unit A is a left neighbor of coded slice NAL unit B, and subpicIdxA is equal to subpicidxB, then the slice NAL unit A shall precede the slice NAL unit B in decoding order.

(Constraint 4): If subpicture across filtering is not allowed, and coded slice NAL unit A is a top neighbor of coded slice NAL unit B, and subpicIdxA is equal to subpicldxB, then the slice NAL unit A shall precede the slice NAL unit B in decoding order.

As described above, according to Embodiment 2 of the present disclosure, a raster scan scheme or an arbitrary slice scan scheme may be selectively applied to slices within a picture. When an arbitrary slice scan scheme is applied to slices within a picture, a range of neighboring slices whose decoding order is restricted may be determined to be the same picture range or the same subpicture range based on whether subpicture across filtering is allowed. Accordingly, since the slice scanning order may be determined by considering the property of the subpicture across filter, encoding/decoding delay can be prevented and efficiency can be further improved.

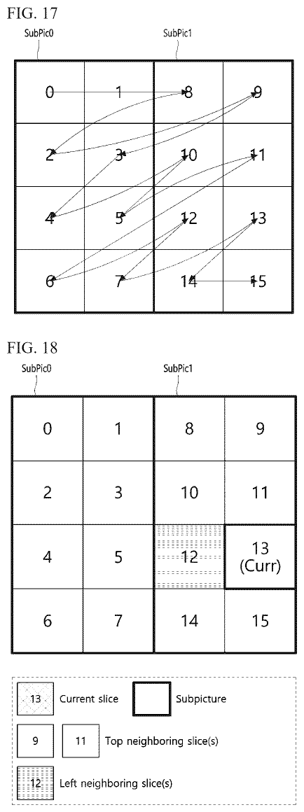

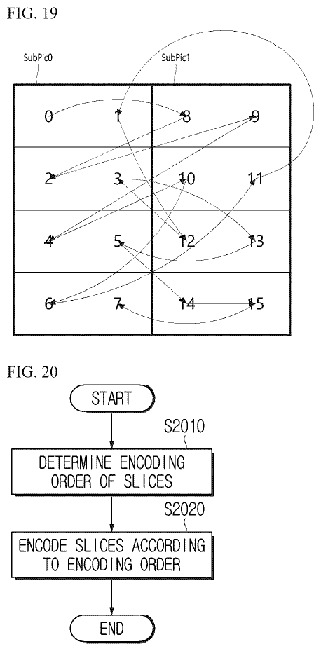

Hereinafter, an image encoding/decoding method according to an embodiment of the present disclosure will be described in detail with reference to FIGS. 20 and 21.

FIG. 20 is a flowchart illustrating an image encoding method according to an embodiment of the present disclosure. The image encoding method of FIG. 20 may be performed by the image encoding apparatus of FIG. 2.

Referring to FIG. 20, the image encoding apparatus may determine an encoding order of a plurality of slices within a current picture (S2010). The encoding order may be determined by one of a raster scan order or arbitrary slice scan ordering. In determining the encoding order, at least one of Aspects 1 to 3 of Embodiment 1 described above may be applied, or at least one of Aspects 4 to 7 of Embodiment 2 described above may be applied.

In an embodiment, based on the encoding order of the plurality of slices being determined to be a different order from the raster scan order (e.g., arbitrary slice scan ordering), a left neighboring slice located on the left side of the current slice within the current picture and a top neighboring slice located above the current slice may be restricted to precede the current slice in the encoding order. In this case, the left neighboring slice does not need to immediately precede the current slice in the encoding order. In addition, the top neighboring slice does not need to immediately precede the current slice in the encoding order.

In an embodiment, based on the slices being not rectangular slices, the encoding order of the plurality of slices may be restricted to the raster scan order.

In an embodiment, based on the current picture including a plurality of subpictures, the encoding order of the plurality of slices may be determined individually for each subpicture.

In an embodiment, based on the current picture including a plurality of subpictures, the encoding order of the plurality of slices may be determined based on whether in-loop filtering across the boundary of the subpictures is allowed. For example, based on the in-loop filtering being allowed for the current picture and the encoding order of the plurality of slices being determined to be a different order from the raster scan order, the encoding order restriction of the above-described neighboring slices may be applied to all slices within the current picture. In contrast, based on the in-loop filtering being not allowed for the current picture and the encoding order of the plurality of slices being determined to be a different order from the raster scan order, the encoding order restriction of the above-described neighboring slices may be applied individually to each subpicture. Meanwhile, based on the in-loop filtering being not allowed for the current picture, the encoding order of slices belonging to different subpictures within the current picture may be determined regardless of the subpicture to which each slice belongs.

In addition, the image encoding apparatus may generate a bitstream by encoding the plurality of slices based on the determined encoding order (S2020). In this case, the encoding data (e.g., slice NAL units) of the plurality of slices may be sorted in the determined encoding order within the bitstream.

FIG. 21 is a flowchart illustrating an image decoding method according to an embodiment of the present disclosure. The image decoding method of FIG. 21 may be performed by the image decoding apparatus of FIG. 3.

Referring to FIG. 21, the image decoding apparatus may determine a decoding order of a plurality of slices within a current picture (S2110). The decoding order may be determined to be one of a raster scan order or arbitrary slice scan ordering. In determining the decoding order, at least one of Aspects 1 to 3 of Embodiment 1 described above may be applied, or at least one of Aspects 4 to 7 of Embodiment 2 described above may be applied.

In an embodiment, based on the decoding order of the plurality of slices being determined to be a different order from the raster scan order (e.g., arbitrary slice scan ordering), a left neighboring slice located on the left side of the current slice within the current picture and a top neighboring slice located above the current slice may be restricted to precede the current slice in the decoding order. In this case, the left neighboring slice does not need to immediately precede the current slice in the decoding order. In addition, the top neighboring slice does not need to immediately precede the current slice in the decoding order.

In an embodiment, based on the slices being not rectangular slices, the decoding order of the plurality of slices may be restricted to the raster scan order.

In an embodiment, based on the current picture including a plurality of subpictures, the decoding order of the plurality of slices may be determined individually for each subpicture.

In an embodiment, based on the current picture including a plurality of subpictures, the decoding order of the plurality of slices may be determined based on whether in-loop filtering across the boundary of the subpictures is allowed. For example, based on the in-loop filtering being allowed for the current picture and the decoding order of the plurality of slices being determined to be a different order from the raster scan order, the decoding order restriction of the above-described neighboring slices may be applied to all slices within the current picture. In contrast, based on the in-loop filtering being not allowed for the current picture and the decoding order of the plurality of slices being determined to be a different order from the raster scan order, the decoding order restriction of the above-described neighboring slices may be applied individually to each subpicture. Meanwhile, based on the in-loop filtering being not allowed for the current picture, the decoding order of slices belonging to different subpictures within the current picture may be determined regardless of the subpicture to which each slice belongs.

In addition, the image decoding apparatus may decode the plurality of slices based on the determined decoding order (S2020). In this case, when performing in-loop filtering on the decoded current slice, the left and top neighboring slices that have been decoded according to the decoding order restriction described above may be used, so that the encoding/decoding delay can be prevented and the efficiency can be further improved.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, a real time communication device such as video communication, a mobile streaming device, a storage medium, a camcorder, a video on demand (VOD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a blu-ray player, an Internet access TV, a home theater system, a smartphone, a tablet PC, a digital video recorder (DVR), or the like.

FIG. 20 is a view showing a content streaming system, to which an embodiment of the present disclosure is applicable.

As shown in FIG. 20, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream, the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In this case, the control server serves to control a command/response between devices in the content streaming system.

The streaming server may receive content from a media storage and/or an encoding server. For example, when the content are received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### Industrial Applicability

The embodiments of the present disclosure may be used to encode or decode an image.

1. An image decoding method performed by an image decoding apparatus, the image decoding method comprising:
determining a decoding order of a plurality of slices within a current picture; and
decoding the plurality of slices based on the determined decoding order,
wherein based on the decoding order of the plurality of slices being determined to be a different order from a raster scan order, a left neighboring slice located on a left side of a current slice within the current picture and a top neighboring slice located above the current slice are restricted to precede the current slice in decoding order.

2. The image decoding method of claim 1, wherein based on the plurality of slices being not rectangular slices, the decoding order of the plurality of slices is restricted to the raster scan order.

3. The image decoding method of claim 1, wherein based on the current picture including a plurality of subpictures, the decoding order of the plurality of slices is determined individually for each subpicture.

4. The image decoding method of claim 1, wherein based on the current picture including a plurality of subpictures, the decoding order of the plurality of slices is determined depending on whether in-loop filtering across a boundary of the subpictures is allowed.

5. The image decoding method of claim 4, wherein based on the in-loop filtering being allowed for the current picture and the decoding order of the plurality of slices being determined to be a different order from the raster scan order, the restriction is applied to all slices within the current picture.

6. The image decoding method of claim 4, wherein based on the in-loop filtering being not allowed for the current picture and the decoding order of the plurality of slices being determined to be a different order from the raster scan order, the restriction is applied individually to each subpicture.

7. The image decoding method of claim 4, wherein based on the in-loop filtering being not allowed for the current picture, the decoding order of slices belonging to different subpictures within the current picture is determined regardless of a subpicture to which each slice belongs.

8. An image encoding method performed by an image encoding apparatus, the image encoding method comprising:
determining an encoding order of a plurality of slices within a current picture; and
encoding the plurality of slices based on the determined encoding order,
wherein based on the encoding order of the plurality of slices being determined to be a different order from a raster scan order, a left neighboring slice located on a left side of a current slice within the current picture and a top neighboring slice located above the current slice are restricted to precede the current slice in encoding order.

9. The image encoding method of claim 8, wherein based on the slices being not rectangular slices, the encoding order of the plurality of slices is restricted to the raster scan order.

10. The image encoding method of claim 8, wherein based on the current picture including a plurality of subpictures, the encoding order of the plurality of slices is determined individually for each subpicture.

11. The image encoding method of claim 8, wherein based on the current picture including a plurality of subpictures, the encoding order of the plurality of slices is determined depending on whether in-loop filtering across a boundary of the subpictures is allowed.

12. The image encoding method of claim 11, wherein based on the in-loop filtering being allowed for the current picture and the encoding order of the plurality of slices being determined to be a different order from the raster scan order, the restriction is applied to all slices within the current picture.

13. The image encoding method of claim 11, wherein based on the in-loop filtering being not allowed for the current picture and the encoding order of the plurality of slices being determined to be a different order from the raster scan order, the restriction is applied individually to each subpicture.

14. The image encoding method of claim 11, wherein based on the in-loop filtering being not allowed for the current picture, the encoding order of slices belonging to different subpictures within the current picture is determined regardless of a subpicture to which each slice belongs.

15. A computer-readable recording medium for storing a bitstream generated by an image encoding method, the image encoding method comprising:
determining an encoding order of a plurality of slices within a current picture; and
encoding the plurality of slices based on the determined encoding order,
wherein based on the encoding order of the plurality of slices being determined to be a different order from a raster scan order, a left neighboring slice located on a left side of a current slice within the current picture and a top neighboring slice located above the current slice are restricted to precede the current slice in encoding order.
